(19) United States
(12) Patent Application Publication
(10) Pub. No.: US 2014/0041612 A1
(43) Pub. Date: Feb. 13, 2014

(54) LASER IGNITION DEVICE

(71) Applicants: Hirohide Furutani, Tsukuba-shi (JP); Akihiro Sone, Hamamatsu-shi (JP); Hiroshi Sakai, Hamamatsu-shi (JP)

(72) Inventors: Hirohide Furutani, Tsukuba-shi (JP); Akihiro Sone, Hamamatsu-shi (JP); Hiroshi Sakai, Hamamatsu-shi (JP)

(73) Assignee: HAMAMATSU PHOTONICS K.K., Hamamatsu-shi, Shizuoka (JP)

(21) Appl. No.: 14/009,407

(22) PCT Filed: Nov. 17, 2011
(86) PCT No.: PCT/JP2011/076561

§ 371 Date: Oct. 2, 2013

(30) Foreign Application Priority Data
Apr. 5, 2011 (JP) 2011-083920

(51) Int. Cl. F02P 23/04

(52) U.S. Cl. CPC F02P 23/04
USPC 123/143 B

(57) ABSTRACT

A laser ignition device 1 for igniting an air-fuel mixture in an auxiliary combustion chamber 85 comprises a target unit 20 arranged within the auxiliary combustion chamber 85 and a laser light source 11, arranged on the outside of the combustion chamber 85, for emitting laser light L for irradiating the target unit 20. The laser light source 11 is a microchip laser.

### TECHNICAL FIELD

The present invention relates to a laser ignition device for igniting an air-fuel mixture in a combustion chamber.

### BACKGROUND ART

Laser ignition devices which fire air-fuel mixtures in combustion chambers by using laser light have been attracting attention as devices for improving the efficiency of gas engines. For example, Patent Literature 1 discloses a laser ignition device of a target breakdown type which converges laser light at a solid-state target placed on the upper face of a piston of an engine, so as to generate plasmas, thereby igniting an air-fuel mixture in a combustion chamber. Patent Literature 2 discloses a laser ignition device of a gas breakdown type which converges laser light at an air-fuel mixture, so as to ignite it.

### CITATION LIST

### Patent Literature

Patent Literature 1: Japanese Patent Application Laid-Open No. 2006-220091
Patent Literature 2: Japanese Patent Application Laid-Open No. 2006-329186

### SUMMARY OF INVENTION

### Technical Problem

However, the laser ignition device disclosed in the Patent Literature 1 mentioned above may fail to generate plasmas so as to ignite the air-fuel mixture unless the laser light converging position is aligned with the solid-state target with high precision. The laser ignition device disclosed in Patent Literature 2, on the other hand, is required to have a large laser power for igniting the air-fuel mixture.

It is therefore an object of the present invention to provide a laser ignition device which can securely generate plasmas so as to ignite air-fuel mixtures while being able to reduce the energy of laser light necessary for ignition.

### Solution to Problem

The laser ignition device in accordance with one aspect of the present invention is a laser ignition device for igniting an air-fuel mixture in a combustion chamber, the laser ignition device comprising a target unit arranged within the combustion chamber and a laser light source, arranged on the outside of the combustion chamber, for emitting laser light for irradiating the target unit, wherein the laser light source is a microchip laser.

This laser ignition device uses a microchip laser for the laser light source. The laser light emitted from the microchip laser has such a high energy per unit area that a wide intensity range can be secured for laser light which can generate plasmas for igniting the air-fuel mixture in the target unit. This makes it possible to securely generate plasmas so as to ignite the air-fuel mixture even when the laser light converging position shifts from the target unit. This laser ignition device also comprises the target unit arranged within the combustion chamber and the laser light source, arranged on the outside of the combustion chamber, for emitting laser light for irradiating the target unit. This laser ignition device irradiates the target unit arranged within the combustion chamber with laser light, so as to generate plasmas, thereby igniting the air-fuel mixture. A target breakdown scheme can achieve ignition by laser light having a lower energy than that in a gas breakdown scheme. Hence, the energy of the laser light necessary for ignition can be reduced.

The laser ignition device may further comprise an optical system for adjusting an intensity range of the laser light adapted to generate a plasma for igniting the air-fuel mixture in the target unit and a converging position of the laser light. Such a structure can adjust the laser light intensity range and converging position to desirable positions with respect to the target unit.

In the laser ignition device, the optical system may adjust the intensity range and converging position such that the intensity range includes the target unit while the converging position is located in front of the target unit. When thus regulated, the intensity range includes the target unit, whereby plasmas can be generated securely, so as to ignite the air-fuel mixture. Thus regulating the converging position makes it possible to ignite the air-fuel mixture directly at the converging position. This can cause both target breakdown and gas breakdown, thereby igniting the air-fuel mixture more securely.

### Advantageous Effects of Invention

The present invention can securely generate plasmas so as to ignite air-fuel mixtures while being able to reduce the energy of laser light necessary for ignition.

### BRIEF DESCRIPTION OF DRAWINGS

FIG. 1 is a diagram for explaining the structure of an engine device equipped with a laser ignition device in accordance with an embodiment;

FIG. 2 is a chart for explaining operations of the laser ignition device in accordance with the embodiment;

FIG. 3 is a set of diagrams for explaining effects of the laser ignition device in accordance with the embodiment;

FIG. 4 is a chart for explaining a first example of the laser ignition device in accordance with the embodiment;

FIG. 5 is a chart for explaining the first example of the laser ignition device in accordance with the embodiment;

FIG. 6 is a chart for explaining a second example of the laser ignition device in accordance with the embodiment;

FIG. 7 is a chart for explaining a third example of the laser ignition device in accordance with the embodiment; and

FIG. 8 is a chart for explaining a fourth example of the laser ignition device in accordance with the embodiment.

### DESCRIPTION OF EMBODIMENTS

In the following, preferred embodiments of the laser ignition device in accordance with the present invention will be explained in detail with reference to the accompanying drawings. In the explanation of drawings, the same constituents will be referred to with the same signs while omitting their overlapping descriptions.

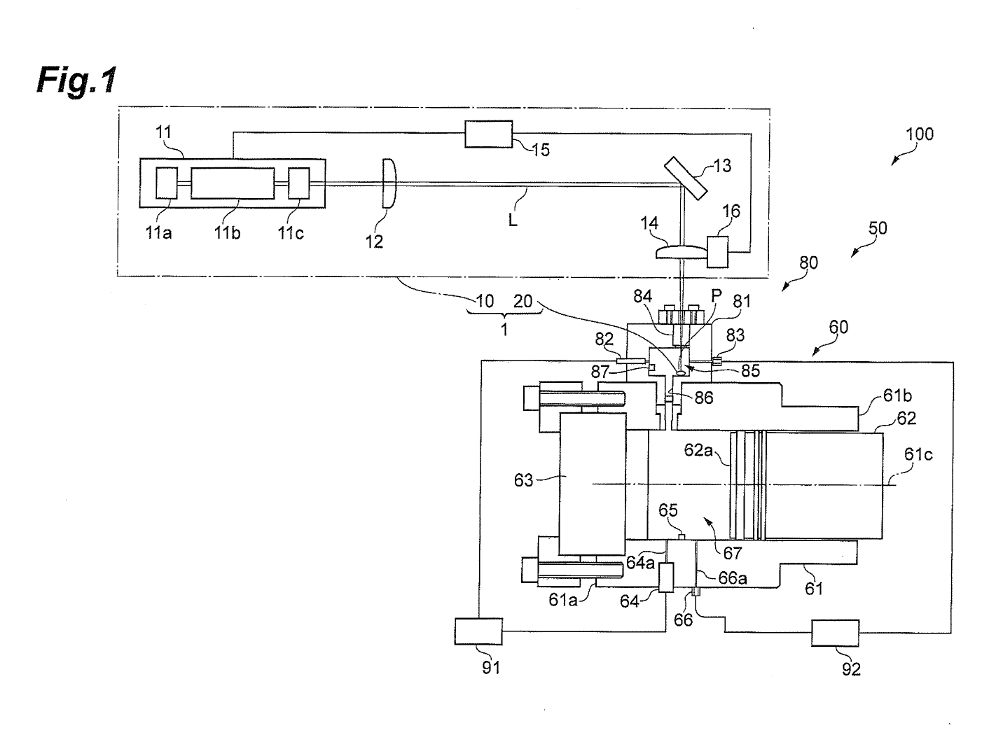

FIG. 1 is a diagram for explaining the structure of an engine device 100 equipped with a laser ignition device 1 in accordance with an embodiment. The engine device 100 comprises a combustion unit 50 and the laser ignition device 1.

The laser ignition device 1 will now be explained. The laser ignition device 1 comprises a laser generation unit 10 and a target unit 20. The laser generation unit 10 comprises a laser light source 11, a collimator 12, a mirror 13, a lens 14, a lens drive unit 16, a target unit 20 and a laser light controller 15.

The laser light source 11 is arranged on the outside of the combustion unit 50. The laser light source 11 has a function to emit laser light L for irradiating the target unit 20. A microchip laser is used for the laser light source 11. The microchip laser is a solid-state laser using a semiconductor laser (LD) for a pumping light source. The laser light source 11 comprises a pumping light source 11a, a laser resonator 11b, and a pulsator 11c. For example, a semiconductor laser is used for the pumping light source 11a. For the laser resonator 11b, Nd:YAG is used, for example. The laser resonator 11b has a length of 20 mm or shorter. For example, one of an external modulator which forcibly performs modulation from the outside and a saturable absorber which performs modulation according to a characteristic of its element per se is used for the pulsator 11c. For the external modulator, an electro-optic modulator (EOM), an acousto-optic modulator (AOM), or the like can be used, for example. For the saturable absorber, Cr:YAG SESAM, or the like can be used, for example.

The collimator 12 is disposed on an optical path of the laser light L. The collimator 12 is used for forming the laser light L as a beam of collimated light.

The mirror 13 is disposed on the optical path of the laser light L. It has a function to control the optical path of the laser light L, so as to guide the laser light L to the target unit 20 through a laser light inlet 84.

The lens 14 is disposed on the optical path of the laser light L. The lens 14 is an optical system for adjusting the intensity range of the laser light L and the location of a converging position P of the laser light L. By the intensity range of the laser light L is meant a range by which a plasma for igniting an air-fuel mixture can be generated in the target unit 20. A lens having a long focal length is preferably used for the lens 14. For example, a lens having a focal length of 100 mm or a lens having a focal length of 150 mm can be used for the lens 14.

The target unit 20 is disposed within an auxiliary combustion chamber 85. In this embodiment, the target unit 20 is disposed on a wall surface opposite from the one provided with the laser light inlet 84. The target unit 20 has a function to generate plasmas when irradiated with the laser light L.

The laser light controller 15 is connected to the lens drive unit 16 for controlling the position of the lens 14. The laser light controller 15 controls the lens drive unit 16, so as to move the lens 14 in directions along the optical path of the laser light L, thereby adjusting the intensity range and converging position P of the laser light L. The converging position P of the laser light L is adjusted so as to be located within the auxiliary combustion chamber 85. Within the auxiliary combustion chamber 85, the converging position P may be adjusted so as to be placed on the surface of the target unit 20, in front of the target unit 20, or at a desirable location on the optical path of the laser light L. The intensity range of the laser light L is adjusted so as to include the target unit 20. The laser light controller 15 is also connected to the laser light source 11. For example, the laser light controller 15 controls the repetition frequency, energy, pulse width, and wavelength of the laser light L emitted from the laser light source 11.

The combustion unit 50 will now be explained. The combustion unit 50 comprises a main combustion unit 60, an auxiliary combustion unit 80, a pressure controller 91, and a gas introduction controller 92. The main combustion unit 60 comprises a combustion chamber body 61, a piston 62, a lid 63, a main pressure regulator 64, a main pressure gauge 65, and a main gas inlet 66. The combustion chamber body 61 has a cylindrical main combustion chamber 67.

The lid 63 is secured to one end part 61a of the combustion chamber body 61, while the piston 62 is inserted therein from the other end part 61b side. The piston 62 is constructed so as to be movable in directions along a center axis 61c of the main combustion chamber 67. By moving in directions along the center axis 61c, the piston 62 compresses or expands the air-fuel mixture in the main combustion chamber 67. The main pressure gauge 65 is disposed on the inner wall surface of the main combustion chamber 67. The main pressure gauge 64 and main gas inlet 66 are disposed on the outer side face of the combustion chamber body 61. The main pressure regulator 64 is connected to the main combustion chamber 67 through a through hole 64a penetrating through the combustion chamber body 61 from its outer wall surface to the main combustion chamber 67.

The auxiliary combustion unit 80 is disposed on the outer side face of the combustion chamber body 61. The auxiliary combustion unit 80 comprises an auxiliary combustion chamber body 81, an auxiliary pressure regulator 82, an auxiliary gas inlet 83, and the laser light inlet 84. The auxiliary combustion chamber body 81 has the auxiliary combustion chamber 85 having a rectangular parallelepiped form.

The auxiliary combustion chamber body 81 has a through hole 86. One end part of the through hole 86 is disposed at a wall surface of the auxiliary combustion chamber 85, while the other end part is disposed at the wall surface of the main combustion chamber 67. Another wall surface opposing the wall surface formed with the through hole 86 is provided with the laser light inlet 84. The laser light inlet 84 is made of silica glass, for example. One of the wall surfaces orthogonal to the laser light inlet 84 is provided with the auxiliary gas inlet 83, while the other is provided with the auxiliary pressure regulator 82.

The pressure controller 91 is connected to the main pressure regulator 64. By adjusting a valve provided with the main pressure regulator 64, the pressure controller 91 controls the internal pressure of the main combustion chamber 67. The pressure controller 91 is also connected to the auxiliary pressure regulator 82. By adjusting a valve provided with the auxiliary pressure regulator 82, the pressure controller 91 controls the internal pressure of the auxiliary combustion chamber 85.

The gas introduction controller 92 is connected to the main gas inlet 66. The gas introduction controller 92 introduces a desirable air-fuel mixture to the main combustion chamber 67 through the main gas inlet 66. The gas introduction controller 92 is connected to the auxiliary gas inlet 83. The gas introduction controller 92 introduces a desirable air-fuel mixture to the auxiliary combustion chamber 85 through the auxiliary gas inlet 83.

First, in the engine device 100 equipped with thus constructed laser ignition device 1, the laser light source 11 emits the laser light L. The laser light L emitted from the laser light source 11 passes through the collimator 12, so as to reach the mirror 13. The laser light L having reached the mirror 13 is thereby caused to change its optical path direction so as to irradiate the target unit 20. The laser light L having changed the optical path direction reaches the lens 14. When passing through the lens 14, the laser light L is refracted so as to converge at the converging position P. The laser light L transmitted through the lens 14 passes through the laser light inlet 84, so as to converge on the surface of the target unit 20, for example.

At this time, the gas introduction control unit 92 has already introduced an air-fuel mixture having a desirable mixing ratio into the main combustion chamber 67 and auxiliary combustion chamber 85. The inside of the main combustion chamber 67 and auxiliary combustion chamber 85 has been adjusted to a desirable pressure by the pressure regulator 91. Plasmas occur on the surface of the target unit 20 where the laser light L is converged. The plasmas ignite the air-fuel mixture introduced in the auxiliary combustion chamber 85, thereby generating a combustion gas. The combustion gas is ejected to the main combustion chamber 67 through the through hole 86. Thus ejected combustion gas ignites the lean premixed air-fuel mixture, thereby rapidly combusting the latter.

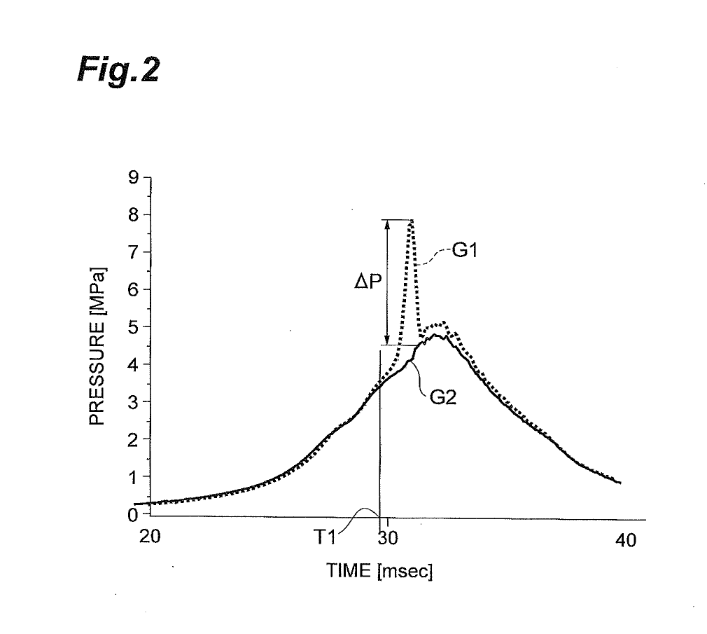

FIG. 2 is a chart for explaining operations of the laser ignition device 1 in accordance with the embodiment and illustrates changes in internal pressures in the main combustion chamber 67 and auxiliary combustion chamber 85 with time. The internal pressure within the main combustion chamber 67 is measured by the main pressure gauge 65, and the internal pressure within the auxiliary combustion chamber 85 is measured by the pressure gauge 87. In FIG. 2, Graph G1 illustrates changes in internal pressure with time in the main combustion chamber 67, and Graph G2 illustrates changes in internal pressure with time in the auxiliary combustion chamber 85. Irradiation with the laser light L occurs at time T1. Referring to the graph G1, the internal pressure drastically rises after the time T1, which indicates that the air-fuel mixture in the main combustion chamber 67 is ignited. It is also expected that, as the pressure difference ΔP between the respective internal pressures of the main combustion chamber 67 and auxiliary combustion chamber 85 is greater, the combustion is easier to occur, whereby the combustion efficiency is higher.

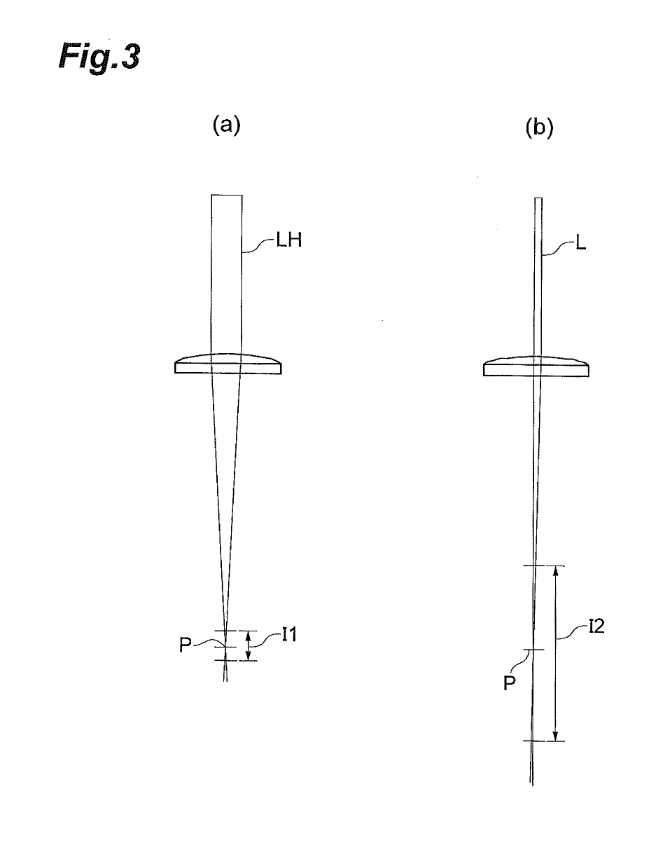

As explained in the foregoing, the laser ignition device 1 in accordance with this embodiment uses a microchip laser for the laser light source 11. With reference to FIG. 3, operations and effects attained by the microchip laser will be explained. FIG. 3 is a set of diagrams for explaining operations and effects attained by the laser ignition device 1 in accordance with this embodiment. FIG. 3(a) illustrates an intensity range I1 in laser light LH emitted from a conventional laser light source. FIG. 3(b) illustrates an intensity range I2 in the laser light L emitted from the laser light source 11 in accordance with this embodiment. The energy of the laser light LH is assumed to be the same as that of the laser light L. Referring to FIGS. 3(a) and 3(b), the laser light L can attain an M² value, which indicates the laser quality, of 1.2 or less even when having the same energy as that of the laser light LH, whereby the diameter of the laser light L can be set to several mm, for example. This can enhance the amount of energy per unit area. Therefore, the intensity range I2 of the laser light L adapted to generate plasmas for igniting the air-fuel mixture in the target unit 20 can be secured widely. Hence, even when the laser light converging position P shifts from the target unit 20, plasmas can be generated securely, so as to ignite the air-fuel mixture.

Since the intensity range I2 of the laser light L can be secured widely, even when the target unit 20 is arranged on the upper face 62a of the piston 62 moving in directions along the center axis 61c, plasmas can be generated securely, so as to ignite the air-fuel mixture, as long as the range of movement of the upper face 62a is included in the intensity range I2 of the laser light L. It is also as effective as a method of simultaneously igniting at a plurality of converging positions P. The microchip laser allows its laser medium to have a size on a par with that of a semiconductor laser and thus can easily make the laser light source 11 smaller.

The laser ignition device 1 in accordance with this embodiment comprises the target unit 20 arranged within the auxiliary combustion chamber 85 and the laser light source 11, arranged on the outside of the auxiliary combustion chamber 85, for emitting the laser light L for irradiating the target unit 20. The laser ignition device 1 irradiates the target unit 20 arranged within the auxiliary combustion chamber 85 with the laser light L, so as to generate plasmas, thereby igniting the air-fuel mixture. The energy of the laser light L necessary for ignition in such a target breakdown ignition scheme is smaller than that in a gas breakdown scheme which directly ignites the air-fuel mixture. Hence, the energy of the laser light necessary for ignition can be reduced. This can lower the energy of the laser light L passing through the laser light inlet 84, thereby decreasing the possibility of the laser light inlet 84 being damaged. This can also reduce the energy of the laser light L irradiating the target unit 20, thereby cutting down the amount of decrease in the target unit 20 caused by the generation of plasmas. Therefore, the number of replacements of the laser light inlet 84 and target unit 20 can be reduced, whereby the life of the laser ignition device 1 can be elongated. Since the energy of the laser light L is smaller, the laser light controller 15 for controlling the laser light L can easily be made smaller. The manufacturing cost for the laser ignition device 1 can also be cut down.

As the target unit 20 wears, the converging position P and the target unit 20 gradually shift from each other. This makes it necessary for conventional ignition devices using the target breakdown scheme to adjust the laser light converging position or replace the target unit. By contrast, the laser ignition device 1 in accordance with this embodiment can secure the intensity range I2 of the laser light L widely and thus can securely generate plasmas, so as to ignite the air-fuel mixture, without frequently adjusting the converging position P or replacing the target unit 20.

In conventional ignition devices using plugs, the discharge voltage increases as their combustion chambers attain higher pressure, whereby the plugs have shorter lives. By contrast, the laser ignition device 1 in accordance with this embodiment irradiates the target unit 20 with the laser light L, so as to generate plasmas, thereby igniting the air-fuel mixture, which makes it unnecessary to use plugs. This allows the laser ignition device 1 to have a longer life than ignition devices using plugs.

Preferably, the laser ignition device 1 in accordance with this embodiment further comprises the lens 14 serving as an optical system for adjusting the intensity range I2 of the laser light L adapted to generate plasmas for igniting the air-fuel mixture in the target unit 20 and the converging position P of the laser light L. Such a structure can adjust the intensity range I2 and converging position P of the laser light L to desirable positions with respect to the target unit 20.

Preferably, in the laser ignition device 1 in accordance with this embodiment, the lens 14 serving as an optical system adjusts the intensity range I2 and converging position P such that the intensity range I2 includes the target unit 20 while the converging position P is located in front of the target unit 20. When thus regulated, the intensity range I2 includes the target unit 20, whereby plasmas can be generated securely, so as to ignite the air-fuel mixture. Regulating the converging position P of the laser light L so as to place it in front of the target unit 20, i.e., in the air-fuel mixture in the auxiliary combustion chamber 85, can directly ignite the air-fuel mixture at the converging position P. This can cause both target breakdown and gas breakdown, thereby igniting the air-fuel mixture more securely. The heat loss to the target unit 20 becomes problematic when combusting lean premixed air-fuel mixtures and fuels with low calorific value. The laser ignition device 1 in accordance with this embodiment can cause the target breakdown and gas breakdown at the same time, thereby solving the problem mentioned above. This is useful in particular when utilizing biogases with low combustion speed and the like.

### Example 1

Using the engine device 100 equipped with the laser ignition device 1 in accordance with this embodiment, effects of the laser ignition device 1 were studied. The laser light L emitted from the laser light source 11 constituted by a microchip laser was configured such as to have (1) a repetition frequency of several Hz or higher, (2) an energy of 0.15 mJ per pulse or higher, (3) a pulse width of 1 nsec or less, (4) a beam quality of 1.2 or less, and (5) a laser wavelength of 532 nm in an absorption wavelength region of the air-fuel mixture. The main combustion chamber 67 and auxiliary combustion chamber 85 were configured such as to have (1) an auxiliary combustion chamber volume of 2.45 cm³, (2) a main combustion chamber volume of 75.60 cm³ at the time of combustion, (3) a compression ratio of 7.29, and (4) a temperature of 80° C. before compression. Methane was used as a fuel. The equivalence ratio indicating the mixing ratio between methane and air was set to 0.6 in the main combustion chamber 67 and to 1.25 in the auxiliary combustion chamber 85. The filling pressure was set to 0.348 MPa in both the main combustion chamber 67 and the auxiliary combustion chamber 85.

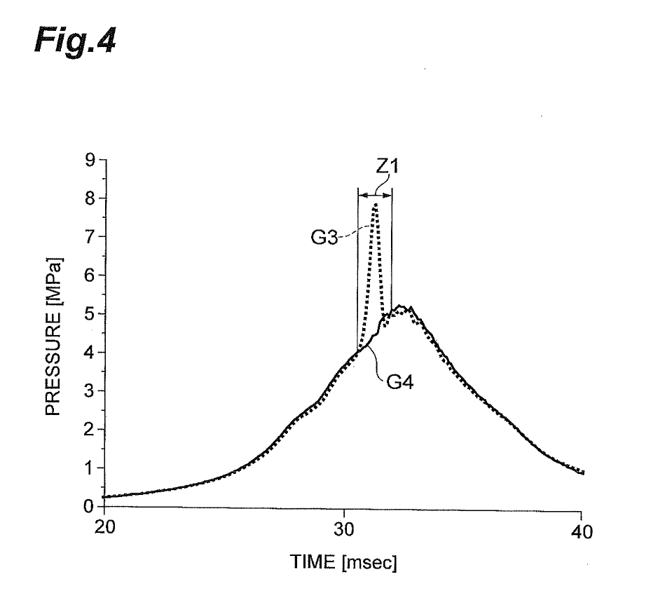

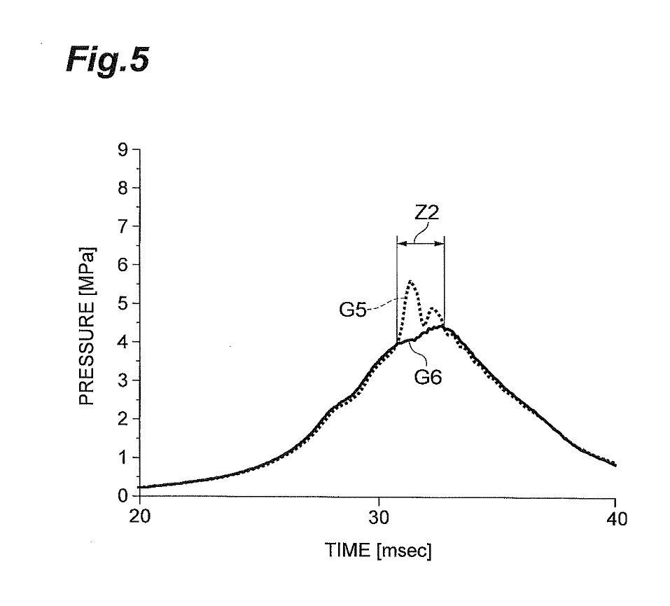

FIGS. 4 and 5 are charts for explaining the effects of the laser ignition device 1 in accordance with this embodiment, illustrating changes in internal pressures of the main combustion chamber 67 and auxiliary combustion chamber 85 with time. FIG. 4 illustrates changes in internal pressures when combusting the air-fuel mixture in the main combustion chamber 67 by irradiating the target unit 20 with the laser light L having an energy set to 0.94 mJ per pulse. In FIG. 4, Graph G3 illustrates changes in internal pressures with time in the main combustion chamber 67, and Graph G4 illustrates changes in internal pressures with time in the auxiliary combustion chamber 85. It is seen from the graph G3 that the internal pressure increased drastically in a zone Z1, which indicates that the combustion of the air-fuel mixture in the main combustion chamber 67 occurred in this zone Z1.

FIG. 5 illustrates changes in internal pressures when combusting the air-fuel mixture in the main combustion chamber 67 by irradiating the target unit 20 with the laser light L having an energy set to 0.21 mJ per pulse. In FIG. 5, Graph G5 illustrates changes in internal pressures with time in the main combustion chamber 67, and Graph G6 illustrates changes in internal pressures with time in the auxiliary combustion chamber 85.

It is seen from the graph G5 that the internal pressure increased drastically in a zone Z2, which indicates that the combustion of the air-fuel mixture in the main combustion chamber 67 occurred in this zone Z2.

### Example 2

Next, the ignitable energy of the laser light L was studied. Here, the converging position P of the laser light L was adjusted to a desirable position, and whether or not the air-fuel mixture of the main combustion chamber 67 could ignite was seen while changing the energy of the laser light L. The laser light L emitted from the laser light source 11 was collimated by the collimator 12 and converged by the lens 14, so as to irradiate the target unit 20. The converging position P was adjusted so as to be placed at 2 mm in front of the target unit 20.

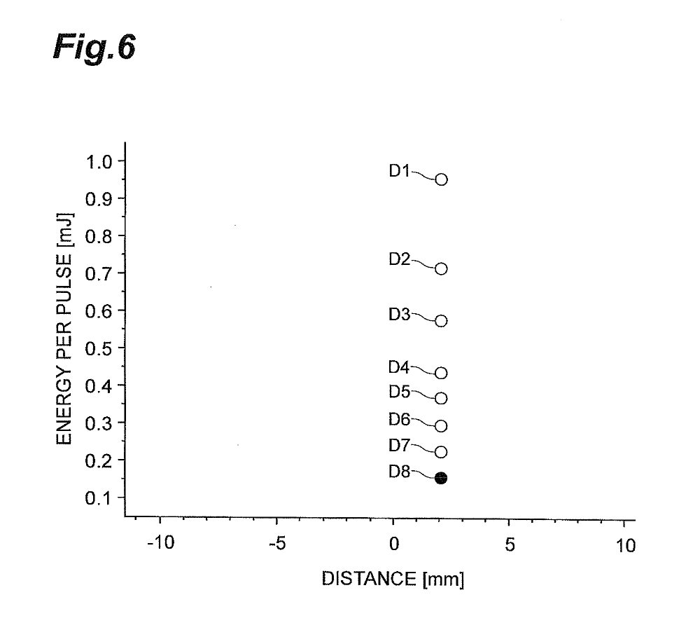

FIG. 6 illustrates the relationship between the energy per pulse of the laser light L irradiating the target unit 20 and whether or not the ignition succeeded. Points D1 to D8 indicate that the ignition succeeded. The points D1 to D7 illustrate the results in the case where the lens 14 has a focal length of 100 mm. The point D8 illustrates the result in the case where the lens 14 has a focal length of 150 mm. It is seen from the points D1 to D7 in FIG. 6 that the ignition succeeded within the range where the energy per pulse was 0.21 mJ to 0.94 mJ when the lens 14 having the focal length of 100 mm was used. It is seen from the point D8 in FIG. 6 that the ignition succeeded even at the energy per pulse of 0.15 mJ when the lens 14 having the focal length of 150 mm was used. This indicates that using the microchip laser for the laser light source 11 and providing it with the lens 14 having a long focal length enables ignition even when the energy of the laser light L is lowered to 0.15 mJ per pulse, for example.

### Example 3

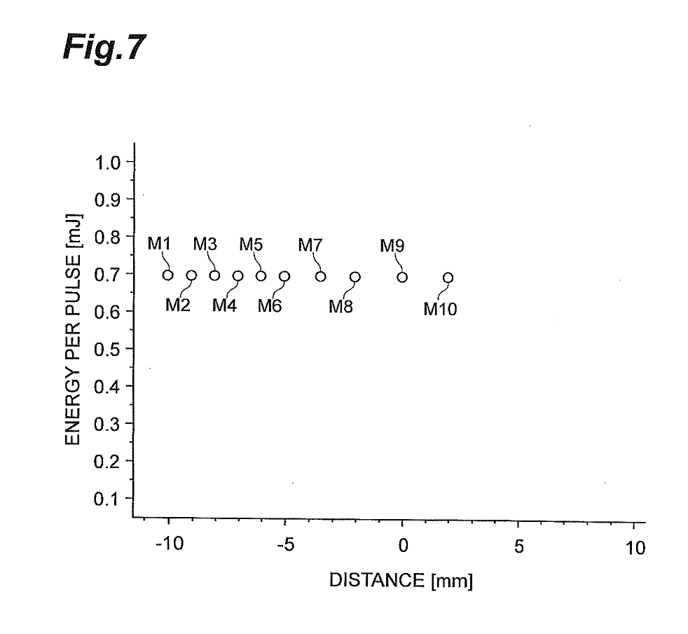

Subsequently, the length of the intensity range I2 of the laser light L was studied. Here, the energy per pulse of the laser light L was set to a desirable value, and whether or not the air-fuel mixture of the main combustion chamber 67 could ignite was seen while changing the converging position P. In this example, the energy per pulse of the laser light L was set to 0.7 mJ. With respect to the converging position P in this example, positive and negative directions were set to the front side of the target unit 20 and a direction opposite thereto, respectively. Then, the converging position P was adjusted stepwise within the range from +2 mm to −10 mm. FIG. 7 illustrates the relationship between the converging position P and whether or not the ignition succeeded. Points M1 to M10 indicate that the ignition succeeded. It is seen from FIG. 7 that the air-fuel mixture in the main combustion chamber 67 could ignite when the converging position P was adjusted so as to be placed within the range from +2 mm to −10 mm with respect to the target unit 20. This has verified that the intensity range I2 having a length of 12 mm can be secured when the laser ignition device 1 in accordance with this embodiment is operated under the condition mentioned above.

### Example 4

Next, whether or not gas breakdown succeeded in ignition was studied. This example was configured such as to have (1) an auxiliary combustion chamber volume of 9.6 cm³, (2) a main combustion chamber volume of 168 cm³ at the time of combustion, (3) a compression ratio of 6.28, and (4) a temperature of 100° C. before compression. The equivalence ratio indicating the mixing ratio between methane and air was set to 0.6 in the main combustion chamber 67 and to 1.25 in the auxiliary combustion chamber 85. The filling pressure was set to 0.250 MPa in both the main combustion chamber 67 the auxiliary combustion chamber 85. The converging position P of the laser light L was adjusted so as to be placed at 10 mm in front of the target unit 20. This converging position P is located at the center between the upper and lower walls of the auxiliary combustion chamber 85. The wavelength of the laser light L was set to 532 nm. The energy per pulse of the laser light L was set to 1.02 mJ. For the lens 14, one having a focal length of 150 mm was used. The settings mentioned above aimed to generate convergent gas breakdown in the air-fuel mixture in the auxiliary combustion chamber 85.

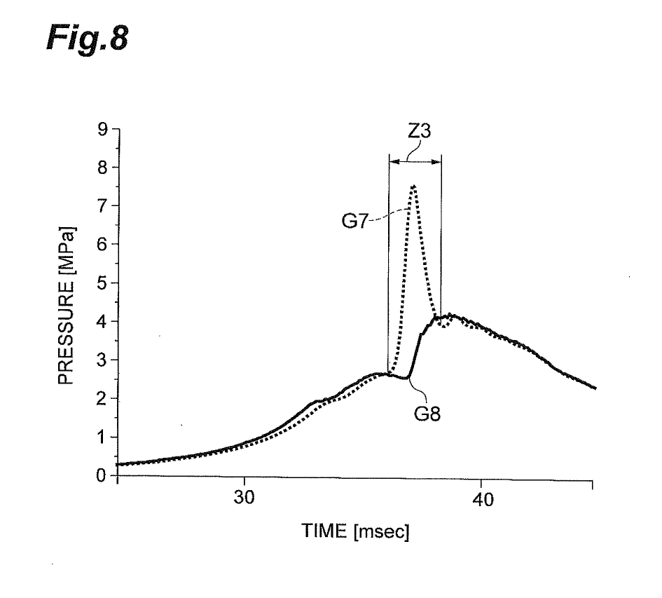

FIG. 8 illustrates changes in internal pressures of the main combustion chamber 67 and auxiliary combustion chamber 85 with time. Graph G7 illustrates changes in internal pressures with time in the auxiliary combustion chamber 85, and Graph G8 illustrates changes in internal pressures with time in the main combustion chamber 67. It is seen from the graph G7 that the internal pressure in the auxiliary combustion chamber 85 increased drastically in a zone Z3. This has verified that operating the laser ignition device 1 in accordance with this embodiment under the condition mentioned above enables ignition by gas breakdown.

### Modified Examples

The present invention is not limited to the embodiment explained in the foregoing. For example, the laser ignition device 1 in accordance with the present invention is applicable not only to engines for vehicles, but also to gas engines used for cogeneration systems. Employing the laser ignition device 1 in accordance with the present invention can improve thermal efficiency in the cogeneration systems. It can also attain a life longer than that of a plug, thereby cutting down the maintenance cost.

### INDUSTRIAL APPLICABILITY

The present invention can securely generate plasmas so as to ignite air-fuel mixtures while being able to reduce the energy of laser light necessary for ignition.

### REFERENCE SIGNS LIST

1 . . . laser ignition device; 11 . . . laser light source; 20 . . . target unit; 67 . . . main combustion chamber; 85 . . . auxiliary combustion chamber; L . . . laser light

1. A laser ignition device for igniting an air-fuel mixture in a combustion chamber, the laser ignition device comprising:
a target unit arranged within the combustion chamber; and
a laser light source, arranged on the outside of the combustion chamber, for emitting laser light for irradiating the target unit;
wherein the laser light source is a microchip laser.

2. A laser ignition device according to claim 1, further comprising an optical system for adjusting an intensity range of the laser light adapted to generate a plasma for igniting the air-fuel mixture in the target unit and a converging position of the laser light.

3. A laser ignition device according to claim 2, wherein the optical system adjusts the intensity range and converging position such that the intensity range includes the target unit while the converging position is located in front of the target unit.
